(19) United States
(12) Patent Application Publication
(10) Pub. No.: US 2026/0109125 A1
(43) Pub. Date: Apr. 23, 2026

(54) METHOD AND DOSE FOR FORMING AN OBJECT WITH A NATURAL FIBRE-BASED MATERIAL

(71) Applicant: SACMI COOPERATIVA MECCANICI IMOLA SOCIETA' COOPERATIVA, IMOLA (BOLOGNA) (IT)

(72) Inventors: FABRIZIO PUCCI, IMOLA (BOLOGNA) (IT); GIOVANNI MAZZOTTI, IMOLA (BOLOGNA) (IT); FIORENZO PARRINELLO, IMOLA (BOLOGNA) (IT); ELEONORA BALDUCCI, IMOLA (BOLOGNA) (IT)

(21) Appl. No.: 19/114,224

(22) PCT Filed: Sep. 25, 2023
(86) PCT No.: PCT/IB2023/059442

§ 371 Date: Mar. 21, 2025

(30) Foreign Application Priority Data
Sep. 23, 2022 (IT) 102022000019518

(51) Int. Cl. B31B 50/59; B27N 5/02

(52) U.S. Cl. CPC B31B 50/59; B27N 5/02

(57) ABSTRACT

A method that includes the steps of supplying a dose made with a natural fibre-based material; inserting the dose in a mould between a first half-mould and a second half-mould and moving at least one half-mould, selected from the first half-mould and the second half-mould towards the other half-mould selected from the second half-mould and the first half-mould, along a pressing direction to press the dose between the first half-mould and the second half-mould and form the object. The dose has a non-uniform structure.

The invention relates to a method and a dose for forming an object with a natural fibre-based material, in particular with a cellulose-based material. For reasons linked to protection of the environment, it is desirable to use natural and renewable materials, for example cellulose-based materials, to produce a multiplicity of objects currently made of synthetic polymeric material, in particular, but not exclusively, in the packaging field. Cellulose-based materials are much less polluting and easier to dispose of than synthetic polymeric materials.

Forming objects is known by pressing doses of cellulose-based material between a male half-mould and a female half-mould.

The doses may have the shape of a flat disc, obtained by cutting a web material made from a cellulose-based material. The flat disc therefore has a constant density and a constant thickness, corresponding to the density and the thickness of the starting web material.

Doses of this type may cause difficulties if they are used to form objects with a non-constant thickness, such as, for example, caps for containers. The caps usually have an end wall which, in use, is intended to be positioned horizontally above an opening surrounded by a neck of the container. A substantially cylindrical lateral wall projects from the end wall, the substantially cylindrical lateral wall having an inner surface on which at least one fastening element is provided for removably fixing the cap to the neck of the container. A tamper-evident ring is provided in an edge zone of the lateral wall, below the fastening element, to alert a user if the container has already been opened.

The tamper-evident ring usually has a thickness less than other parts of the cap, in particular less than the end wall which, on the other hand, has a relatively high thickness. The tamper-evident ring may also be provided with retaining tabs to keep the tamper-evident ring associated with the neck of the container, the retaining tabs being thinner than other parts of the cap.

More generally speaking, the entire lateral wall may have a thickness less than the end wall, which cannot be too thin because it has to sealingly close the container and withstand the pressures which develop inside it.

This means that, when the dose is pressed between the male half-mould and the female half-mould, in the zones of the dose intended to form the tamper-evident ring and more generally the lateral wall a pressure has to be applied greater than that which has to be applied in the zones of the dose intended to form the end wall. By compressing more the zones of the dose intended to form the tamper-evident ring, it is possible to obtain in the tamper-evident ring a smaller thickness than in other zones of the cap.

This, however, involves constructional complications in the moulding apparatus, which has to be able to locally apply very high moulding pressures at the thinner zones. Moreover, providing a mould which is able to apply different pressures in different zones of the cap generates significant complications from the point of view of design and construction of the mould.

In addition to the above, the object obtained at the end of the forming process has non-uniform properties. For example, the density of the cellulose-based material is generally greater in the lateral wall, where the material has been more compressed, than in the end wall. This is generally undesired.

The doses having the shape of a disc may create difficulties during compression when they are used to obtain objects with a concave shape, for example caps, capsules or containers. These objects have a substantially flat end wall from which a lateral wall projects, the lateral wall extending about an axis.

Whilst the central part of the dose intended to form the end wall does not experience particular difficulties during compression, it is more difficult to process the peripheral part of the dose intended to form the lateral wall, which has to be bent relative to the central part and slide until filling the outermost regions of the forming chamber.

It may also occur that, when the peripheral part of the dose is deformed to form the lateral wall, thereby passing from a flat shape to a concave shape, folds are formed on the lateral wall of the object, in which adjacent portions of material are superposed. These folds cause non-uniformity in the properties of the formed object, which has a higher density and therefore a greater stiffness at the folds, and they may also be visible to the naked eye, which worsens the appearance of the object.

Some examples of methods for forming objects with natural fibre-based materials are disclosed in SE 1950299, JP 2006069071, DE 3825986, US 2017/305097.

An object of the invention is to improve the methods for forming an object by pressing a natural fibre-based material.

Another object is to improve the doses made with a natural fibre-based material that are suitable for undergoing forming by means of compression to obtain objects.

Still another object is to provide a method for obtaining an object by pressing a dose, and the relative dose, which allow objects to be obtained which, even though they have a non-constant thickness, have properties which are as uniform as possible.

A further object is to provide a method for forming an object by pressing a dose, and the relative dose, which allow objects to be obtained having a non-constant thickness and a good quality.

Another object is to provide a dose which allows a three-dimensional object to be formed, particularly an object having a concave shape, in which the defects due to the presence of folds in the lateral wall are reduced or eliminated.

Another object is to provide a method for forming a concave object by pressing a dose in a mould, and the relative dose, which make it possible to easily fill the mould.

In a first aspect of the invention, there is provided a method comprising the steps of:
supplying a dose made with a natural fibre-based material;
inserting the dose in a mould between a first half-mould and a second half-mould;
moving at least one half-mould selected from the first half-mould and the second half-mould towards the other half-mould selected from the second half-mould and the first half-mould along a pressing direction to press the dose between the first half-mould and the second half-mould and form the object,
   wherein the dose has a non-uniform structure.

Instead of using a dose having uniform properties or a uniform geometry in its entire volume, in the method according to the first aspect of the invention a dose is used having a non-uniform structure, designed as a function of the type of object to be formed. The non-uniform structure is configured to optimise the behaviour of the natural fibre-based material during pressing and/or to improve the distribution of properties in the pressed object.

In an embodiment, the non-uniform structure of the dose is defined by a variation of a property of the dose between a first portion of the dose and a second portion of the dose.

For example, the non-uniform structure of the dose may be defined by a variation of a property of the dose between a central portion of the dose and a peripheral portion of the dose.

This embodiment is particularly suitable for doses intended to form concave objects. In this case, it is possible to make the behaviour of the central portion of the dose, intended to form an end wall of the object, different from the behaviour of the peripheral portion, intended to form a lateral wall of the object.

The central portion is arranged in a central region of the dose.

The peripheral portion is delimited by an outer edge or free edge of the dose. If the dose has a substantially circular shape in plan view, the central portion has, in plan view, a circular shape, whilst the peripheral portion has, in plan view, an annulus shape.

In an embodiment, the dose may comprise an intermediate portion, interposed between the central portion and the peripheral portion, in which the property which varies has an intermediate value between the value which that property has in the central portion and the value which that property has in the peripheral portion.

In an embodiment, the property that varies to make the structure of the dose non-uniform is the thickness.

In particular, the thickness may be greater in a first portion of the dose intended to form a thicker wall of the object, and smaller in a second portion of the dose intended to form a thinner wall of the object.

This allows to eliminate, or anyway reduce, density variations in an object formed by pressing the dose, the object having a non-constant thickness, in particular having a thicker wall and a thinner wall. A thicker zone of the object may be obtained from a thicker portion of the dose, whilst a thinner zone may be obtained from a thinner portion of the dose. This makes unnecessary differentiating the forming pressure between the thinner zone and the thicker zone. Consequently, excessive complications are avoided in the structure of the apparatus which forms the object. Moreover, excessive density differences between the thinner zone and the thicker zone of the object are avoided.

For example, the thickness may be greater in a central portion of the dose and less in a peripheral portion of the dose.

In an embodiment, the property that varies to make the dose structure non-uniform is density.

In particular, density may be greater in a first portion of the dose intended to form a thicker zone of the object, and smaller in a second portion of the dose intended to form a thinner zone of the object.

In this embodiment, the dose may have a constant or substantially constant thickness.

By pressing the dose with a substantially uniform forming pressure, it is possible to obtain a thicker part of the object from the first portion of the dose, which has a greater density, whilst a thinner part of the object can be obtained from the second portion of the dose, which has a lower density. This avoids complications of the forming apparatus and avoids excessive variations of density in the finished object.

In an embodiment, the non-uniform structure of the dose may be defined by at least one intended deformation line made on a surface of the dose.

This makes it possible to control the behaviour of the dose during pressing, in such a way as to making easier forming an object having a three-dimensional shape, for example a non-flat shape, in particular a concave shape.

The intended deformation line may be a line which surrounds a central portion of the dose, intended to form an end wall of the object.

This makes it easier, during forming, to fold a peripheral portion of the dose, which surrounds the intended deformation line, with respect to the central portion of the dose, arranged inside the intended deformation line.

In this way it is possible to obtain a concave object, in which the central portion of the dose creates an end wall of the object and the peripheral portion of the dose creates a lateral wall of the object. The intended deformation line makes easier forming the dose, and in particular helps the peripheral portion to be arranged around a punch of the mould in which the object is formed, in order to form the lateral wall of the object.

The natural fibre-based material may thus more easily fill a forming chamber of the mould, even if the object to be formed has a concave shape.

The intended deformation line may be a closed line, for example circular.

Inside the intended deformation line, it is thus possible to enclose the central portion of the dose, intended to form the end wall of the object.

In an embodiment, the peripheral portion of the dose has a plurality of further intended deformation lines which extend from the intended deformation line towards the outside of the dose.

During forming, the further intended deformation lines help the deformation of the peripheral portion of the dose, which more easily creates a lateral wall having a cylindrical shape, or a truncated cone shape or the like.

In an embodiment, the intended deformation line is a local compression zone provided in the dose.

The local compression zone defines a linear zone in the dose along which the material has been deformed by pressing it. This makes it easier to form a concave object from the dose, because the peripheral portion of the dose rotates more easily relative to the central portion to form the lateral wall of the object which projects from the end wall.

The further intended deformation lines may also be local compression zones.

The dose may have a multilayer structure and may, for example, comprise a covering sheet arranged in contact with a supporting layer.

If the intended deformation line and/or the further intended deformation lines are local compression zones, adhesion of the covering sheet to the supporting layer is improved, because the local compression zones compress the covering sheet and facilitate a mechanical adhesion of the covering sheet to the supporting layer.

In an embodiment, the intended folding line is a cutting line which partly cuts the thickness of the dose.

The cutting line interrupts continuity of the fibres of the natural fibre-based material, which facilitates deformation of the peripheral portion relative to the central portion and therefore the forming of the lateral wall.

In a second aspect of the invention, there is provided a dose made with a natural fibre-based material, the dose being intended to be subjected to forming by means of pressing to obtain an object, wherein the dose has a non-uniform structure.

The dose provided by the second aspect of the invention makes it possible to obtain the technical effects described above with reference to the first aspect of the invention.

In a third aspect of the invention, there is provided a dose made with a natural fibre-based material, the dose being suitable for undergoing forming by means of pressing to obtain a concave object, the dose comprising a central portion for forming an end wall of the concave object and a peripheral portion for forming a lateral wall of the concave object, the peripheral portion comprising a plurality of functional zones, and wherein a plurality of compensating zones are furthermore provided for receiving excesses of the material of the dose so as to compensate for any increases in thickness due to folds created while the peripheral portion is shaped to form the lateral wall, each compensating zone being interposed between two functional zones.

Owing to the compensating zones, the dose according to the third aspect of the invention allows a concave object to be obtained having a more uniform distribution of the natural fibres in the lateral wall.

Indeed, the compensating zones act as accumulating zones which can receive quantities of materials derived from folds formed in the peripheral portion when the latter is pressed to obtain the lateral wall. This prevents excess material on the lateral wall from giving rise to defective zones in which an excessive degree of compaction has been reached.

The compensating zones may comprise zones with lower density, or zones with smaller thickness, or empty spaces.

The invention can be better understood and implemented with reference to the accompanying drawings which illustrate non-limiting example versions of it and in which:

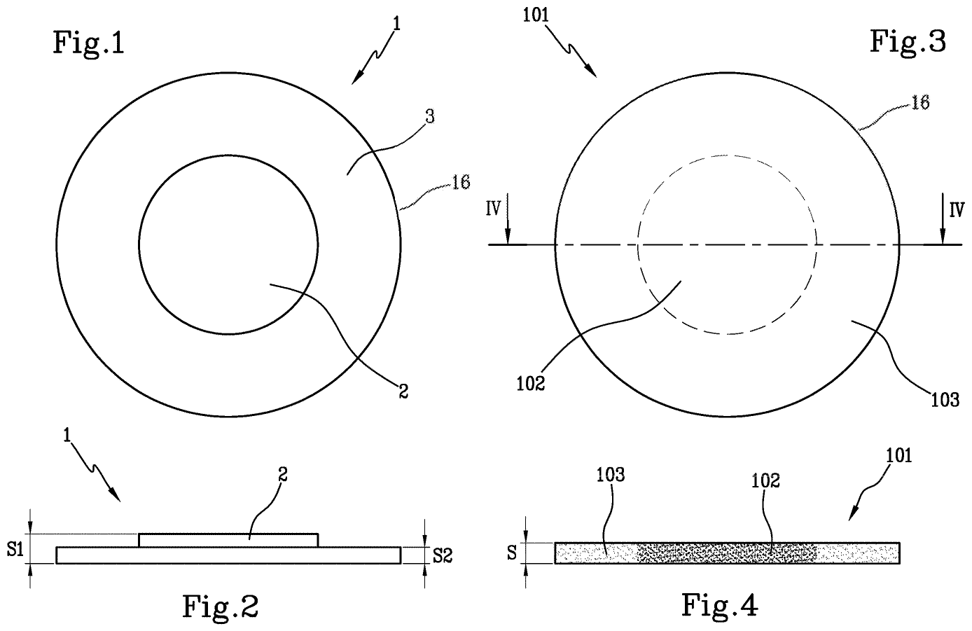

FIG. 1 is a schematic top view of a dose for obtaining an object by pressing;

FIG. 2 is a side view of the dose of FIG. 1;

FIG. 3 is a schematic top view of a dose according to an alternative embodiment;

FIG. 4 is a cross-section along the plane IV-IV of FIG. 3;

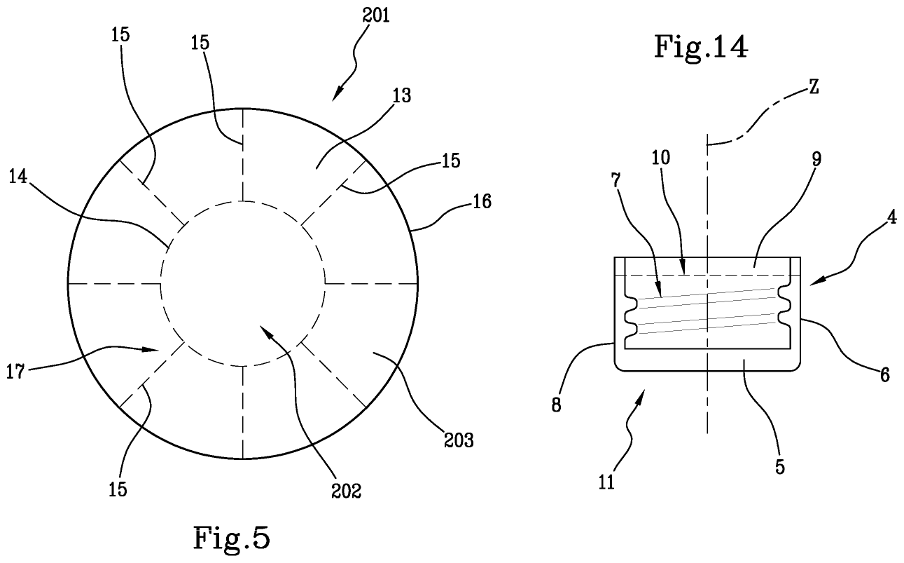

FIG. 5 is a schematic top view of a dose according to another alternative embodiment;

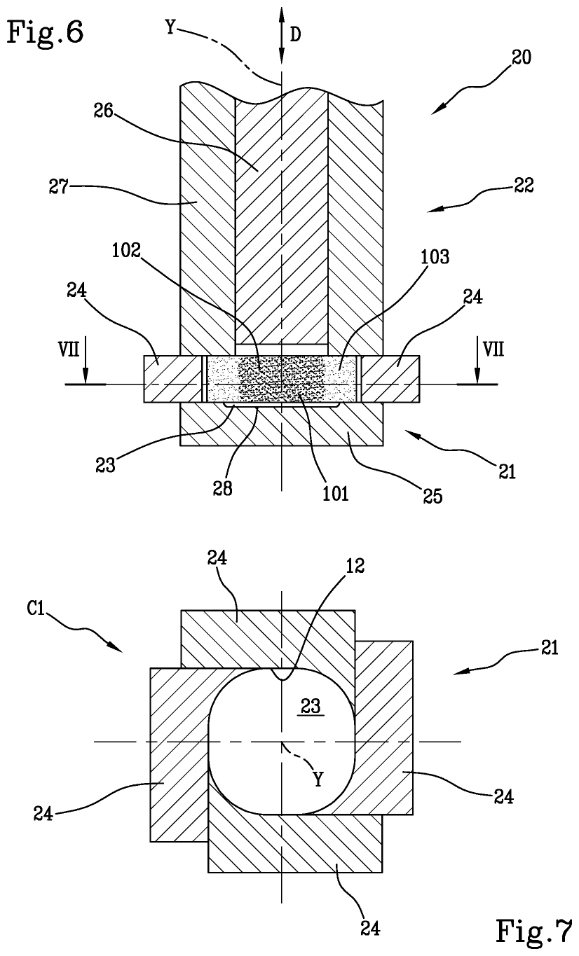

FIG. 6 is a schematic cross-section showing a mould in which a dose can be processed of the type shown in FIGS. 1 to 5, according to a first operating configuration;

FIG. 7 is a cross-section along the plane VII-VII of FIG. 6, in which the dose has not been shown;

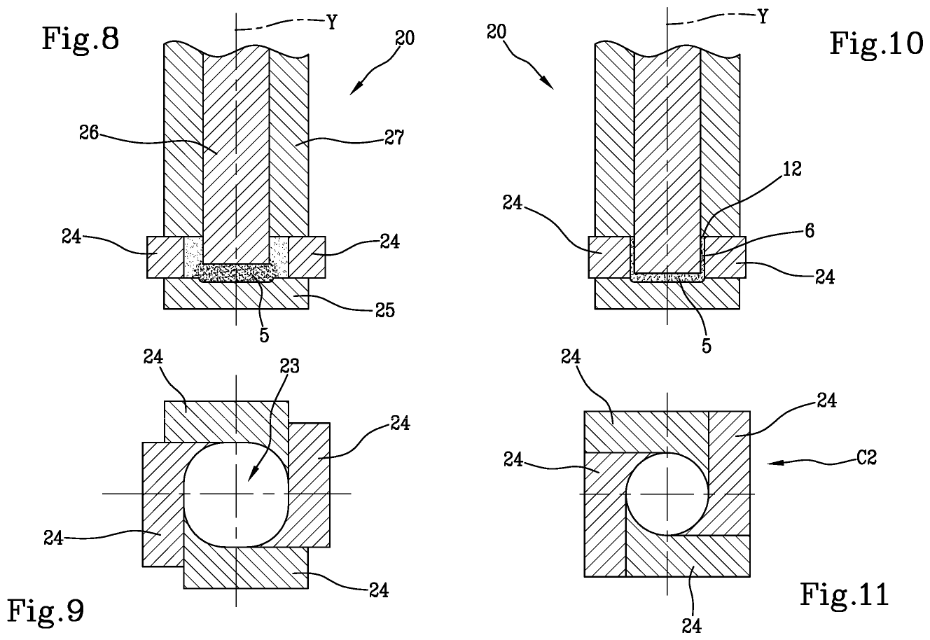

FIG. 8 is a cross-section like that of FIG. 6, according to a second operating configuration;

FIG. 9 is a cross-section like that of FIG. 7, referred to the second operating configuration;

FIG. 10 is a cross-section like that of FIG. 6, according to a third operating configuration;

FIG. 11 is a cross-section like that of FIG. 7, referred to the third operating configuration;

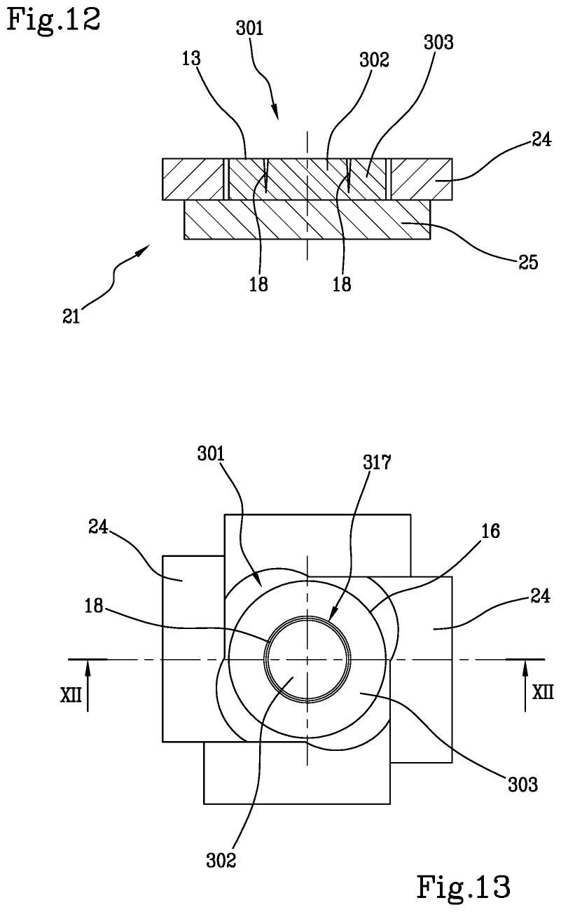

FIG. 12 is a schematic cross-section showing a first half-mould of a mould such as that shown in FIG. 6, in which a dose has been released according to a further alternative embodiment;

FIG. 13 is a schematic top view of the half-mould of FIG. 12;

FIG. 14 is a schematic cross-section, in a reduced scale, of a cap which may be obtained from the doses of FIGS. 1 to 4;

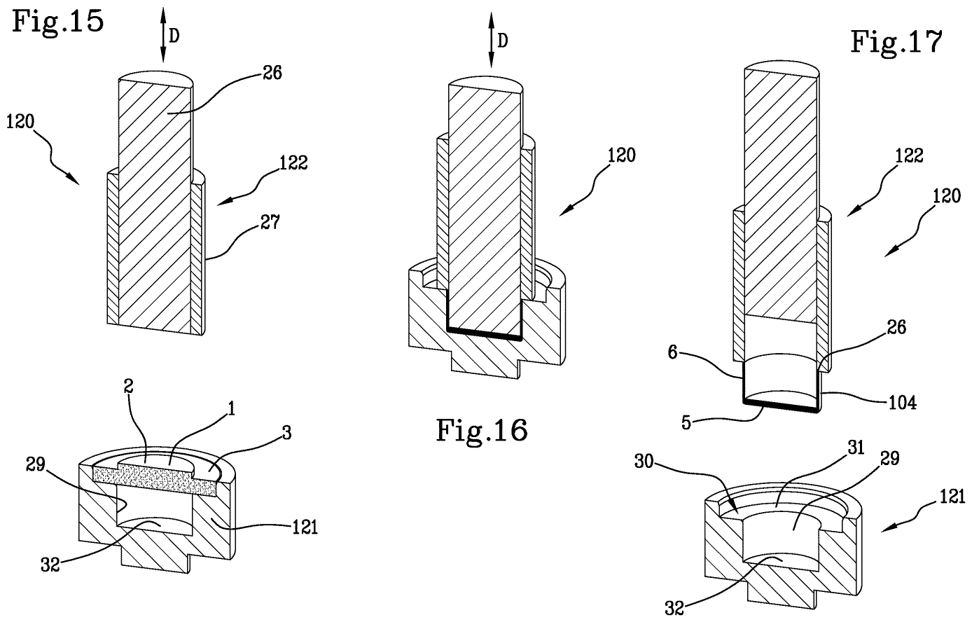

FIG. 15 is a schematic cross-section, showing a dose like that of FIGS. 1 and 2, positioned in a mould according to an alternative embodiment, in which the mould is in an open position;

FIG. 16 is a schematic cross-section like that of FIG. 15, in which the mould is in a forming position;

FIG. 17 is a schematic cross-section like that of FIG. 15, in which the mould is again in an open position and an object formed is extracted from the mould;

FIGS. 18 to 21 are schematic plan views showing doses according to respective alternative embodiments;

FIG. 22 is a schematic cross-section showing a dose according to another alternative version;

FIG. 23 is a schematic cross-section showing a capsule which may be produced starting from a dose of a type shown above.

FIG. 1 shows a blank or dose 1 for obtaining an object by means of pressure forming, in particular by means of compression moulding.

The dose 1 is made of a natural fibre-based material, in particular a cellulose-based material. The material of the dose 1 may comprise a quantity of cellulose equal to at least 70% by weight, for example greater than, or equal to, 80% by weight.

The material with which the dose 1 is made may be in a dry form or may contain a limited percentage of moisture. This material may, for example, be in the form of a fluff, an air-laid structure, a mixture of powder and/or granules, if necessary pre-compacted.

In the examples shown, the dose 1 is shaped like a disc. In other words, the dose 1 may have a circular shape in plan view. However, this condition is not necessary, and other shapes are possible for the dose 1, for example an elliptical, quadrilateral, polygonal and other shape in plan view. It is also possible to use a holed dose, that is to say, a dose provided with a through hole, for example located in a central region of the dose. The holed geometry is useful if the dose is to be used for producing an object having a hole, such as, for example, a neck of a container.

The above statements regarding the shape of the dose apply not only to the dose 1 shown in FIGS. 1 and 2, but to all the doses in which reference is made in this description.

The dose 1 may have a substantially flat shape, or more precisely a shape in which one dimension is much smaller than the other two. More specifically, the dose 1 may have two transversal dimensions (for example, the length of the base and the width of the base, or a diameter) which are much greater than a longitudinal dimension (for example, the thickness or height). The transversal dimensions may, in certain cases, be greater than the longitudinal dimension by at least one order of magnitude.

However, this condition is not necessary and, according to an alternative embodiment, the dose could have three dimensions approximately of the same order of magnitude.

In the dose 1 it is possible to identify a central portion 2 and a peripheral portion 3. The peripheral portion 3 surrounds the central portion 2.

The peripheral portion 3 is delimited by an outer edge 16 of the dose 1. According to the example shown, the peripheral portion 3 extends from the central portion 2 up to the outer edge 16.

According to the example shown, the central portion 2 has a substantially circular shape in plan view and the peripheral portion 3 has a shape in plan view like an annulus arranged around the central portion 2.

The shape of the central portion 2 and of the peripheral portion 3 may be different from that shown, depending on the shape of the dose 1.

The central portion 2 has a thickness S1, which may be substantially constant in the central portion 2. The peripheral portion 3 has, on the other hand, a further thickness S2, which may be substantially constant in the peripheral portion 3. The central portion 2 differs from the peripheral portion 3 because the thickness S1 of the central portion 2 is on average greater than the further thickness S2 of the peripheral portion 3. In other words, the dose 1 is thinner in the peripheral portion 3 than in the central portion 2.

The dose 1 therefore has a non-uniform structure, caused by the variation in thickness in the body of the dose 1. In other words, the variation in thickness between the central portion 2 and the peripheral portion 3 makes the dose 1 not uniform.

The dose 1 may have a substantially uniform density.

The dose 1 may be used to form a concave object, for example a cap for a container, or a container, or a capsule or the like.

FIG. 14 shows an example of a cap 4 which may be produced using the dose 1 shown in FIGS. 1 and 2. The cap 4 is configured to removably engage with a neck of a container and comprises an end wall 5 which, in use, is suitable for being positioned above a mouth of the container, the opening being defined by the neck. The cap 4 also comprises a lateral wall 6 which projects from the end wall 5 and which may extend about an axis Z.

The lateral wall 6 comprises a skirt 8, defined by a portion of the lateral wall 6 adjacent to the end wall 5. Inside the skirt 8 there is a connecting structure 7, which may comprise one or more threads, or one or more projections, or any other connecting element suitable for removably connecting the cap 4 to the neck of the container.

In an alternative embodiment, the connecting structure 7 may be configured for connecting at least a part of the cap 4 to the neck of the container in a non-removable manner, as in the case of a snap cap.

The lateral wall 6 may also comprise a tamper-evident band 9, shown very schematically in FIG. 14. The tamper-evident band 9 is arranged at an end of the skirt 8 opposite the further end of the skirt 8 adjacent to the end wall 5.

The end wall 5 and the skirt 8 define a closing element 11 of the cap 4. The closing element 11 is movable between a closed position, in which the closing element 11 engages with the neck of the container to keep the latter closed, and an open position, in which the closing element 11 is spaced from the mouth of the container in such a way as to allow a user to gain access inside the container.

In the open position, the closing element may be totally detached from the tamper-evident band or remain partly anchored to the tamper-evident band, for example by means of a hinge structure or at least one connecting strip. The tamper-evident band 9 is connected to the skirt 8 by a breakable connection, comprising, for example, a plurality of breakable bridges 10 suitable for being broken the first time the closing element 11 is moved to the open position. By breaking the breakable bridges 10, the closing element 11 is detached completely or partly from the tamper-evident band 9. The tamper-evident band 9 is configured to remain associated with the neck of the container even when the closing element 11 is moved to the open position. For this purpose, the tamper-evident band may comprise one or more retaining elements formed inside the tamper-evident band 9 and suitable for engaging with a collar which projects from the neck of the container, in order to prevent the tamper-evident band 9 from being pulled out from the neck.

The tamper-evident band 9 can have a thickness on average less than the average thickness of the end wall 5. In some cases, the skirt 8 can also have a thickness on average less than the average thickness of the end wall 5. This may occur because, whilst the end wall 5 requires good mechanical strength and excellent properties in terms of the seal with liquids and gases, the sealing properties and the mechanical strength of the lateral wall 6 (or in some cases only for the tamper-evident band 9) may be less critical.

The cap 4 is obtained in a mould by pressing the dose 1 between a male half-mould and a female half-mould, as described in detail below.

According to the example shown, the central portion 2 of the dose 1 is intended to form the end wall 5 of the cap 4. The peripheral portion 3 of the dose 1 is intended, on the other hand, to form the lateral wall 6 of the cap 4.

The central portion 2, which has a thickness S1 greater than the further thickness S2 of the peripheral portion 3, is intended to form the thickest wall of the cap 4. Similarly, the peripheral portion 3, which has a further thickness S2 less than the thickness S1 of the central portion 2, is intended to form the thinner wall of the cap 4.

This makes it possible to obtain a cap 4 having the desired thickness values in the end wall 5 and in the lateral wall 6, using a constant forming pressure, that is to say, using substantially the same forming pressure to form the end wall 5 and to form the lateral wall 6. This prevents structural complications in the forming apparatus used to form the cap 4 compressing the dose 1.

Moreover, the resulting cap 4 has density values which are substantially constant, or which differ slightly, between the end wall 5 and the lateral wall 6.

The difference between the thickness S1 of the central portion 2 and the further thickness S2 of the peripheral portion 3 depends on many factors, including the density of the dose 1 and the thickness to be obtained for the end wall 5 and the lateral wall 6. By way of example, the difference between the thickness S1 of the central portion 2 and the further thickness S2 may vary between 0.5 mm and 10 mm.

The plan view dimensions of the central portion 2 and of the peripheral portion 3 vary depending on the type and the dimensions of the object to be obtained. For example, the peripheral portion 3 may have a radial dimension less than that shown in FIG. 1, if a reduced thickness is to be obtained only in the tamper-evident band 9 and not in the skirt 8.

FIGS. 3 and 4 show a dose 101 according to an alternative version. Unlike that shown in FIGS. 1 and 2, the dose 101 has a substantially constant thickness S.

In the dose 101, however, it is possible to identify a central portion 102 and a peripheral portion 103 which differ from each other in terms of the density of the natural fibre-based material, particularly cellulose-based material, from which it is made.

In particular, in the central portion 102 the natural fibre-based material may have a density greater than the density of that material in the peripheral portion 103.

For example, the central portion 102 may have a grammage variable between 600 and 1200 g/m², preferably equal to 900 g/m². The grammage is closely correlated with the density of the material.

The peripheral portion 103 may, on the other hand, have a grammage variable between 250 and 750 g/m².

The dose 101 therefore has a non-uniform structure, caused by the variation in density in the body of the dose 101. In other words, the variation in density between the central portion 102 and the peripheral portion 103 makes the dose 101 not uniform.

The dose 101 may be used to obtain the cap 4 shown in FIG. 14. In this case, by applying a constant forming pressure on the entire surface of the dose 101, it is possible to form a cap 4 in which the parts which derive from the central portion 102 of the dose 101 have a greater thickness than the parts which derive from the peripheral portion 103 of the dose 101.

For example, if the central portion 102 is sized in such a way as to form the end wall 5 of the cap 4 and the peripheral portion 103 is sized in such a way as to form the lateral wall 6 of the cap 4, it is possible to obtain a cap from the dose 101 having an end wall 5 which is on average thicker than the lateral wall 6.

If, on the other hand, the peripheral portion 103 of the dose 101 had a radial dimension less than that shown in FIGS. 3 and 4, it would be possible to obtain a cap 4 having a tamper-evident band 9 which is on average thinner than the skirt 8 and the end wall 5.

FIGS. 6 to 11 show, in a very schematic manner, an example of a mould 20 which may be used to form a concave object such as the cap 4. In order to simplify the representation, the lateral wall 6 is shown in FIGS. 6 to 11 as delimited by smooth cylindrical lateral surfaces, even though it is understood that the lateral wall 6 may comprise the connecting structure 7 and the tamper-evident band. Moreover, the dose 101 is shown as having dimensions different from that shown in FIGS. 3 and 4. However, the dose 101 still comprises a peripheral portion 103 in which the density is greater than the density in the central portion 102.

Also in this case, the peripheral portion 103 is positioned outside the central portion 102 and extends up to the outer edge 16 or free edge.

The mould 20 comprises a first half-mould or female mould part 21 and a second half-mould or male mould part 22. At least one half-mould selected between the female part 21 and the male part 22 is movable relative to the other half-mould selected between the male part 22 and the female part 21, along a pressing direction D parallel to a moulding axis Y.

The mould 20 has a forming region 23, in which the natural fibre-based material is shaped to obtain the cap 4. The forming region 23 has a volume which may be progressively reduced from the moment the forming region 23 receives the natural fibre-based material, until the moment the cap 4 is obtained. The forming region 23 is therefore a forming region with variable volume.

The female part 21 comprises a plurality of sectors 24, for example four sectors 24, designed to define a lateral surface of the forming region 23.

Each sector 24 is in contact with two adjacent sectors 24.

The sectors 24 are slidable in contact with a transversal element 25 which defines a transversal surface of the forming region 23, that is to say, a surface of the forming region 23 which extends transversely to the pressing direction D.

In particular, the sectors 24 are slidable to pass from an initial position, shown in FIGS. 6 and 7, to a final position, shown in FIGS. 10 and 11. FIGS. 8 and 9 show an intermediate position which the sectors 24 reach between the initial position and the final position.

The sectors 24 can move under the action of one or more external actuators. In particular, each sector 24 can move by the effect of the force exerted on it by a respective external actuator and simultaneously by the force exerted on it by an adjacent sector 24.

The male part 22 comprises a punch 26, which extends along the moulding axis Y and is positioned to penetrate in the forming region 23 so as to shape from the inside the cap 4.

Outside the punch 26 there is a tubular element 27, relative to which the punch 26 can slide.

An actuating device, not illustrated, makes it possible to move the female part 21 and/or the male part 22 relative to each other, so that the female part 21 and the male part 22 move towards each other to form the cap 4 or alternatively move away from each other to allow the formed cap 4 to be removed from the mould 20.

During the operation, the female part 21 and the male part 22 are initially in a spaced position, in which a conveying device, not illustrated, introduces the dose 101 in the forming region 23.

The sectors 24 are located in the initial position, in which they define a wide configuration C1 of the forming region 23. The sectors 24 therefore delimit a forming region 23 having a relatively large volume, which is able to receive a dose 101 having a relatively low density, even if not constant, which consequently occupies a lot of space.

The female part 21 and the male part 22 are moved towards each other until the tubular element 27 makes contact against the sectors 24, as shown in FIG. 6. When this occurs, a closed forming chamber 28 is defined between the female part 21 and the male part 22, having a volume much greater than the final volume of the cap 4.

The punch 26 is initially in a withdrawn position, in which it does not protrude from the tubular element 27, as shown in FIG. 6.

Subsequently, the punch 26 penetrates in the forming region 23 and moves towards the transversal element 25, until positioning at a distance from the transversal element 25 which is substantially equal to the thickness of the end wall 5 of the cap 4, as shown in FIGS. 8 and 9. The end wall 5 of the cap 4 is thus formed.

The sectors 24, which until now have been in the first position, corresponding to the wide configuration C1 of the forming region 23, are now starting to move towards each other. The second position of the sectors 24, shown in FIGS. 10 and 11, is thus reached, corresponding to a final configuration C2 of the forming chamber 28. In this configuration, the sectors 24 are positioned at a distance from the punch 26 which corresponds to the thickness of the lateral wall 6 of the cap 4. The lateral wall 6 is thus compressed, thanks to the interaction between the sectors 24 and a lateral portion of the punch 26.

A free edge 12 of the lateral wall 6 is formed following the interaction between the natural fibre-based material and a portion of surface of the tubular element 27.

The cap 4 thus formed may now be extracted from the mould.

In this way, it is possible to obtain a cap 4, or more generally a concave object, in which the density of the end wall 5 is substantially equal to the density of the lateral wall 6, even though the walls have different thicknesses.

During the pressing or compression moulding of the natural fibre-based material in the mould 20, pressures greater than 200 bar are applied on the material. The natural fibre-based material is heated to reach a temperature in the range of 150-200° C. The heating of the natural fibre-based material may occur in the mould 20 and/or upstream of the latter, in such a way that the natural fibre-based material arrives in the mould 20 already at the desired temperature.

According to an alternative version, the mould 20 may pass from the initial position shown in FIGS. 6 and 7 to the final position shown in FIGS. 10 and 11 also following a sequence of movements different from that described above, for example by moving the punch 26 towards the transversal element 25 before moving the sectors 24 or even simultaneously.

The mould 20 may also be used for forming a concave object by pressing, for example the cap 4, using a dose having a non-constant thickness, of the type shown in FIGS. 1 and 2.

FIGS. 15 to 17 show a mould 120 according to an alternative version. The mould 120 allows the production of a concave object 104 from a dose 1 of the type shown in FIGS. 1 and 2. According to an alternative version not illustrated, the mould 120 could also be used in combination with a dose 101 of the type shown in FIGS. 3 and 4.

The mould 120 comprises a first half-mould, which in the example shown is a female mould part 121, facing a second half-mould, which in the example shown is a male mould part 122.

The male part 122 is similar to the male part 22 shown in FIGS. 6 to 11 and in particular comprises the punch 26 and the tubular element 27.

The female part 121 is provided with a cavity 29 having a predetermined size. Unlike what happens in the mould 20 shown in FIGS. 6 to 11, the female part 121 has transversal dimensions (that is to say, perpendicular to the pressing direction D) which do not vary during the forming. That is to say, the sectors 24 are not present in the female part 121.

The female part 121 is positioned below the male part 122.

The female part 121 has a receiving space 30, intended to temporarily receive the dose 1 when the latter is released in the mould 120, before the dose 10 is compressed following the interaction between the female part 121 and the corresponding male part 122. The receiving space 30 is delimited by a supporting surface 31, which extends transversely, in particular perpendicularly, to the pressing direction D.

The supporting surface 31 is spaced from a bottom surface 32 of the cavity 29.

The dose 1 has a transversal dimension, that is to say, a dimension measured transversely, in particular perpendicularly, to the pressing direction D, which is greater than the transversal dimensions of the receiving space 30.

In this way, when the dose 1 is released between the female part 121 and the male part 122, the dose rests on the receiving space 30 and remains spaced from the bottom surface 32, as shown in FIG. 15.

Subsequently, the female part 121 moves towards the male part 122, or vice versa, moving along the pressing direction D, the dose 1 starts to interact with the punch 26 and is thus pushed inside the cavity 29 until reaching the bottom surface 32. The mould 120 reaches the closed position shown in FIG. 16, in which the dose 1 has been compressed to obtain from it the object 104.

According to the example shown, the object 104 has an end wall 5, obtained from the central portion 2 of the dose 1, which is thicker than the lateral wall 6, obtained from the peripheral portion 3 of the dose 1.

Subsequently, the female part 121 and the male part 122 are again moved away from one another to reach the open position. The tubular element 27 is moved towards the female part 121 relative to the punch 26, in such a way that the tubular element 27 exerts a thrust on the free edge 12 of the object 104 and detaches the object 104 from the punch 26. The object 104 may now be moved away from the mould 120, which is ready to receive a new dose 1.

The mould 120 shown in FIGS. 15 to 17 may also be used for forming objects starting from a dose of the type shown in FIGS. 3 and 4.

The mould 20 shown in FIGS. 6 to 11 may be provided with a receiving space similar to the receiving space 30 shown in FIGS. 15 to 17, in such a way that, also in the mould 20, the dose is initially positioned in a configuration spaced from a bottom surface of the female part 21.

FIG. 21 shows a dose 401 according to an alternative version.

The dose 401 differs from the doses 1 and 101 because it comprises three portions, each of which has a different value of a property selected between the thickness of the dose or the density of the natural fibre-based material which forms the dose.

More specifically, the dose 401 comprises a central portion 402 positioned in a central region of the dose 401 and a peripheral portion 403 positioned outside the central portion 402. The peripheral portion 403 extends up to an outer edge 16 of the dose or free edge. The outer edge 16 delimits the peripheral portion 403.

The dose 401 also comprises an intermediate portion 404 interposed between the central portion 402 and the peripheral portion 403.

According to the example shown, in which the dose 401 has a substantially circular shape in plan view, the central portion 402 also has a substantially circular shape in plan view. The intermediate portion 404 has the shape of a circular crown, positioned immediately outside the central portion 402 and surrounding the latter. The peripheral portion 403 also has the shape of a circular crown. The peripheral portion 403 surrounds the intermediate portion 404.

The dose 401 may also have a non-circular shape in plan view. In this case, the shape of the central portion, the peripheral portion, and the intermediate portion, if present, is consequently modified. In any case, the central portion extends in a central zone of the dose, whilst the peripheral portion has a closed annular shape, delimited by the outer edge 16.

In the central portion 402, a property of the dose 401 selected between the thickness and the density has a first value P1. In the peripheral portion 403, said property has a second value P2. In the intermediate portion 404, said property has an intermediate value P3.

The values P1, P2, P3 are values of the same property, for example the thickness, or the density.

The first value P1 may be greater than the intermediate value P3, which is in turn greater than the second value P2.

For example, in the central portion 402 the thickness may have a first value P1 greater than the intermediate value P3 of the thickness in the intermediate portion 404. The intermediate value P3 may in turn be greater than the second value P2 which the thickness has in the peripheral portion 402.

In a dose of this type, the density may be constant.

According to an alternative version, the density of the natural fibre-based material in the central portion 402 may have a first value P1 greater than the intermediate value P3 of the density in the intermediate portion 404. The intermediate value P3 may in turn be greater than the second value P2 which the density has in the peripheral portion 402.

In a dose of this type, the thickness may be constant.

A dose in which the thickness, or the density, has a first value P1 greater than the intermediate value P3, in turn greater than the second value P2, may be pressed to obtain a cap 11 of the type shown in FIG. 14, in which the end wall 5 has a thickness greater than the thickness of the skirt 6, which in turn is greater than the thickness of the tamper-evident band 9. Thanks to the shape of the dose, the desired thicknesses for the various parts of the cap 11 may be obtained with a substantially constant forming pressure. Moreover, the cap 11 obtained may have a substantially uniform density.

In an alternative embodiment, the dose 401 may have a thickness, or a density, having a first value P1 less than the intermediate value P3, which is in turn less than the second value P2. A dose of this type may be used to form a capsule 411 shown schematically in FIG. 23.

The capsule 411 is intended to contain, for example, a substance in powder or granular form, at least one ingredient of which can be extracted from a pressurised fluid which passes through the capsule. The capsule 411 may, for example, contain coffee, tea or other substances intended to produce a beverage. The capsule 411 comprises a bottom wall 405, a lateral wall 406 which projects from the bottom wall 405 about an axis Z1 and a flange 409 which surrounds the lateral wall 406.

The flange 409 is intended to engage with a supporting component of an extractor machine for sending in the capsule 411 the pressurised fluid. The flange 409 should therefore have a relatively large thickness so as to have a good rigidity.

The bottom wall 405 is intended to be perforated to allow the outflow of the beverage or other liquid which is formed in contact with the substance contained in the capsule 411. For this reason, it is desirable that the bottom wall 405 has a thickness less than the thickness of the flange 409.

The lateral wall 406 may have the same thickness as the bottom wall 405 or a thickness greater than that of the bottom wall 405, but less than that of the flange 409.

The capsule 411 may be obtained by pressing a dose 401 of the type shown in FIG. 21, in which the central portion 402 has a property, selected between thickness and density, having a first value P1 less than a second value P2 which the same property has in the peripheral portion 403. In the intermediate portion 404, the property selected between thickness and density may have an intermediate value P3 greater than the first value P1 and less than the second value P2.

If the property the value of which increases passing from the first value P1 to the second value P2 is the density, the thickness of the dose 401 may be constant. If, on the other hand, the property the value of which increases passing from the first value P1 to the second value P2 is the thickness, the density of the dose 401 may be constant.

If a capsule 411 is to be formed in which the lateral wall 406 and the bottom wall 405 have an equal thickness, less than the thickness of the flange 409, it is possible to use a dose in which the peripheral portion is in direct contact with the central portion, that is to say, a dose in which there is not an intermediate portion having an intermediate density or thickness value between the values present in the central portion and in the peripheral portion.

In general, the size, shape and position of the portions of different thicknesses of the dose 1, 401 or of the portions of different density of the dose 101, 401 may be selected depending on the type of object to be obtained, its shape and its dimensions. The dose is therefore designed as a function of the object to be obtained, for example differentiating the properties or characteristics of the dose, such as the density or thickness, as a function of the thickness of the object which is formed by the dose. Thus, higher densities (or greater thicknesses) are adopted in the portions of the dose intended to form thicker parts of the object, and lower densities (or smaller thicknesses) in the portions of the dose intended to form thinner parts of the object.

For example, starting from a dose having a relatively thick peripheral portion, or having a relatively high density, it is possible to obtain a cap having a tamper-evident band thicker than other parts of the cap. This may be desired if a reliable tamper-evident band is to be obtained which is difficult to fraudulently break, in such a way that the consumer can easily detect any tampering with the container.

Moreover, the portions of the dose having properties different to each other, for example different density or thickness values, are not necessarily positioned in such a way that one of the portions surrounds the other. Depending on the geometry of the object to be formed, the portions of the dose having different properties may be positioned alongside one another or according to other patterns.

In the dose it is also possible to identify more than two portions having values of thickness, density, or other properties different to each other, for example three or more portions which differ in terms of the thickness, the density or another property, depending on the geometry of the object to be formed.

According to a version not illustrated, portions of the dose which differ due to their properties, for example the thickness or density, may give rise to parts of the object having densities different from each other and also having the same thickness or thicknesses different from each other. In this way, it is possible to obtain objects having a different density locally, for locally modifying the performance of the object formed, for example in terms of strength, deformability, seal or the like.

For example, a central portion of the dose could have a property, selected between the thickness and the density, which is greater than the value of that property in a portion positioned in contact with the central portion. By compressing this dose with a greater pressing force at the central portion, it is possible to obtain an object having a substantially uniform thickness. This object has, in a relative part obtained from the central portion, a density greater than the density of the adjacent parts. The part of the object obtained from the central portion of the dose is therefore more rigid than the adjacent parts.

FIG. 5 shows a dose 201 according to an alternative version, which may be used to form a concave object, for example a cap 4, in a mould of the type shown in FIGS. 6 to 11, or in a forming mould by compression different from that shown in FIGS. 6 to 11, such as, for example, in the mould of FIGS. 15 to 17.

The dose 201 comprises at least one intended deformation line 17 made on a surface 13 of the dose 201 to control the deformation of the dose 201 when the latter is pressed between the first half-mould and the second half-mould. The surface 13 may be a surface intended to define an inner surface of the finished object. According to the example shown, there is a plurality of intended deformation lines 17. The intended deformation lines 17 are configured in such a way that, when the dose 201 is pressed between the first half-mould and the second half-mould, the natural fibre-based material is facilitated to bend along the intended deformation lines 17.

The number of intended deformation lines 17 can be chosen as desired. There may be a number of intended deformation lines 17 different from that shown in FIG. 5 and also a single intended deformation line 17.

In the example shown in FIG. 5, each intended deformation line 17 is a local compression zone, that is to say, a line obtained by locally compressing the natural fibre-based material. During the localised compression, action is taken on the natural fibre-based material with a tool which locally deforms and presses the natural fibre-based material, without substantially breaking the fibres. The local compression zone defines on the dose 201 a sort of crease along which the folding of the natural fibre-based material occurs in a facilitated fashion.

The intended deformation lines 17 make the structure of the dose 201 non-uniform, because they introduce a localised deformation in predetermined zones of the dose 201.

According to the example shown, the intended deformation lines 17 comprise a closed local compression zone 14 which surrounds a central portion 202 of the dose 201. According to the example shown, in which the dose 201 has a shape in plan view like a circular disc, the local compression zone 14 is a circular line. Other shapes of the closed local compression zone 14 are possible, depending on the geometry of the dose 201 and the shape and dimensions of the object to be obtained by pressing the dose 201.

In general, the closed local compression zone 14 is intended to delimit a central portion of the dose 201 intended to create a first wall of the object, for example a transversal wall or end wall of a cap, of a capsule or of a container or other concave object.

A peripheral portion 203 of the dose 201 can be identified outside the closed local compression zone 14. The peripheral portion 203 is intended to create, following the forming by pressing, a second wall of the object, which projects from the first wall and surrounds an axis of the object. The second wall may be a lateral wall of a cap, of a capsule or of a container and may optionally have a substantially cylindrical or truncated cone shape.

When the dose 201 is compressed between a first half-mould and a second half-mould, in particular between a female part 21, 121 of the mould and a male part 22, 122 of the mould, the natural fibre-based material positioned outside the closed local compression zone 14 tends to bend relative to the central portion 202, so as to be distributed about the moulding axis Y between an outer lateral surface of the punch and an inner lateral surface of the female mould.

According to the example shown in FIG. 5, the intended deformation lines 17 also comprise a plurality of further local compression zones 15, which extend from the closed local compression zone 14 towards an outer edge 16 of the dose 201. The further local compression zones 15 may be straight lines, for example directed radially. However, other shapes of the further local compression zones 15 are possible.

The further local compression zones 15 help the deformation of the natural fibre-based material when this material is pressed between the first half-mould and the second half-mould. In particular, the local compression zones 15 help the natural fibre-based material to distribute about the moulding axis Y, passing from a substantially flat shape in the dose 201 to a substantially cylindrical or truncated cone shape in the pressed object.

The local compression zone 14 and the further local compression zones may be continuous local compression zones or interrupted local compression zones, that is to say, comprising a plurality of segments in which the material has been locally compressed between which are interposed zones in which the material has not been locally compressed.

In some cases, the natural fibre-based material which forms the dose 201 may have a multilayer structure and may, for example, comprise at least a main or supporting layer, which is thicker, covered at least on a relative face with a covering layer or sheet, having, for example, a smoother and more compact consistency than the supporting layer.

The local compression zones 14, 15, as well as influencing the behaviour of the natural fibre-based material during pressing, allow the adhesion of the covering layer to the supporting layer to be improved. Owing to the localised pressure applied to the natural fibre-based material when the local compression zones are made, the covering layer tends to remain attached to the supporting layer even without using adhesive substances.

The dose 201 may be used to form an object in a mould of the type shown in FIGS. 6 to 11, or in a mould of a different type in which the cavity of the female part has fixed transversal dimensions and the sectors 24 are absent, for example the mould of FIGS. 15 to 17.

FIGS. 12 and 13 show a dose 301 according to another alternative version, positioned inside a female part 21 of a mould of the type shown in FIGS. 6 to 11. It is understood that the dose 301 may also be pressed in a mould of a type different from the mould 20, for example a mould in which the sectors 24 are absent and the cavity of the female part has fixed transversal dimensions, as in the case of the mould of FIGS. 15 to 17.

The dose 301 has an intended deformation line 317 shaped like a cutting line 18, not passing through the entire thickness of the dose 301. The intended deformation line 317 is that obtained by cutting the natural fibre-based material for a part of its thickness. Along the cutting line 18, the fibres of the material which forms the dose 301 have been broken due to the cut. For example, the cutting line 18 can penetrate in the dose 301 for more than half its thickness.

The cutting line 18 is made on a surface 13 of the dose 301 which, also in this case, may be intended to form an inner surface of the finished object. The cutting line 18 makes the structure of the dose 301 non-uniform, because it locally interrupts the continuity of the fibres and makes the behaviour of the natural fibre-based material along the cutting line 18 different from that in the other regions of the dose 301.

The cutting line 18 ideally divides the dose 301 into a central portion 302, surrounded by the cutting line 18, and into a peripheral portion 303, positioned outside the cutting line 18.

The peripheral portion 302 is intended to form a transversal wall or end wall of the object which will be formed by the dose 301, whilst the peripheral portion 303 is intended to form a lateral wall of the finished object.

The cutting line 18 may be a closed line, for example a circular line if the end wall intended to be formed by the central portion 302 has a circular shape in plan. The cutting line 18 may have shapes different from the circular shape, depending on the shape of the wall of the object which the central portion 302 is intended to form.

The cutting line 18 may be continuous or interrupted.

According to the example shown, there is a single cutting line 18 in order not to excessively weaken the natural fibre-based material.

According to an alternative version, there may be two or more cutting lines. When the dose 301 is pressed between the first half-mould and the second half-mould, the central portion 302 is flattened between the punch and the transversal element 25 to create the end wall of the object. The peripheral portion 303 of the dose 301, thanks to the local interruption of the fibres caused by the cutting line 18, has a high freedom of movement and can easily bend and be positioned around the punch to form the lateral wall of the object.

According to the examples of FIGS. 5, 12 and 13, the non-uniformities of the dose, whether they are in the form of local compression zones or cutting lines, are designed to favour, in the mould, a desired type of deformation of the dose.

It is also possible to use a dose formed from a loose material, for example in the form of granules or powder. In this case, the dose may have one or more preferential deformation lines which are created when the dose is formed, for example inside a forming chamber in which the loose material is compacted to obtain the dose.

The preferential deformation lines, whether they are in the form of cut lines, local compression zones or grooves obtained when the dose is formed, may also be facing towards a face of the dose intended to form an outer surface of the object, that is to say, on the part on which the object has a convexity. FIGS. 18 to 20 show examples of doses to obtain concave objects, that is to say, having an end wall and a lateral wall, for example cylindrical or truncated cone, which projects from the end wall. A cavity is defined between the lateral wall and the end wall.

FIG. 18 shows a dose 501 having a central portion 502 which may optionally have a constant density and a constant thickness. Outside the central portion 502 there is a peripheral portion 503 which comprises a plurality of compensating zones 505 to compensate for the overlaps of material which occur when the peripheral portion 503 is shaped so as to obtain a lateral wall of the concave object.

The peripheral portion 503 also comprises a plurality of functional zones 506, having density and thickness values selected in such a way as to obtain the desired properties in the lateral wall of the concave object.

The compensating zones 505 and the functional zones 506 are distributed about a perimeter of the central portion 502 in an alternating manner, each compensating zone 505 is interposed between two functional zones 506 and vice versa.

The compensating zones 505 may each have at least one property, selected between the thickness and the density, which has a value less than the value of that property in the functional zones 506.

The compensating zones 505 may have constant thickness and density. The functional zones 506 may also have constant thickness and density, equal to, or different from, the thickness and density of the central portion 502. However, the density may be less in the compensating zones 505 than in the functional zones 506. In this case, the dose 501 may have a constant thickness.

The compensating zones 505 extend for a significant fraction of the surface of the dose 501, in a plan view of the latter. More in detail, the compensating zones 505 can extend, in their entirety (that is to say, considering the sum of the areas of all the compensating zones 505) for at least 20% of the surface of the dose 501, in a plan view.

According to the example shown, the dose 501 has a substantially circular shape in plan view, even though this condition is not necessary. The dose 501 is delimited by an outer edge 16 or free edge, which in the example shown is circular, in a plan view. The central portion 502 has a substantially circular perimeter, concentric with the outer edge 16.

The compensating zones 505 may have the shape of circular crown portions, having an angular dimension equal to each other.

The functional zones 506 may also have the shape of circular crown portions, having an angular dimension equal to each other.

The angular dimension of the functional zones 506 may be equal to the angular dimension of the compensating zones 505, or different from the angular dimension of the compensating zones 505.

When the dose 501 is pressed in a mould to obtain the concave object, the end wall of the object is obtained starting from the central portion 502 of the dose 501, which is pressed and compressed modifying in a limited manner the relative initial shape.

The lateral wall of the concave object requires, on the other hand, a more marked deformation of the dose portion from which it is formed, that is to say, the peripheral portion 503, which must rotate from a flat configuration, substantially coplanar with the central portion 502, to a three-dimensional configuration, so as to be positioned transversely to the central portion 502. During this deformation, some zones of the lateral portion 503 are superposed, since they bend over each other. The compensating zones 505 are intended to compensate for the excess material which is generated when zones of the lateral portion 503 are superposed. In effect, the excess material, deriving from the overlapping or folds which are created when the lateral wall of the object is formed, may be distributed in the compensating zones 505, which are initially less dense and/or less thick. In this way, the distribution of the material in the lateral wall of the object is improved and made more uniform.

The embodiment described above with reference to FIG. 18 relates to the case in which the density of the compensating zones 505 is less than the density of the functional zones 506, under equal conditions of thickness.

It is also possible to envisage a case in which the thickness of the compensating zones 505 is less than the thickness of the functional zones 506, under equal conditions of density.

FIG. 19 shows a dose 601 according to an alternative embodiment, having a central portion 602 similar to the central portion 502 shown in FIG. 18. The dose 601 also has a peripheral portion 603 comprising a plurality of functional zones 606 similar to the functional zones 506 shown in FIG. 18.

There is also a plurality of empty compensating zones 605, that is to say, in which no material is present. Each compensating zone 605 is an empty space interposed between two consecutive functional zones 606.

When the dose 601 is shaped to obtain the concave object, the functional zones 606, as well as being compressed, rotate relative to the central portion 602 and widen in a circumferential direction, so that the sides of two adjacent functional zones 606 touch and join to form an uninterrupted lateral wall. The compensating zones 605, in which the material of the dose is absent, are filled by the material of the functional zones 606 and prevent overlapping, or minimise overlapping.

In the example shown in FIG. 19, each compensating zone 605, in which the material is absent, extends between two functional zones 606 up to the central portion 602, which creates the end wall of the object.

The peripheral portion 603 has a discontinuous configuration around the central portion 602, in which full spaces, that is to say, the functional portions 606, alternate with empty spaces, that is to say, the compensating portions 606.

In this case, too, it is possible to envisage non-circular shapes in plan of the dose 601.

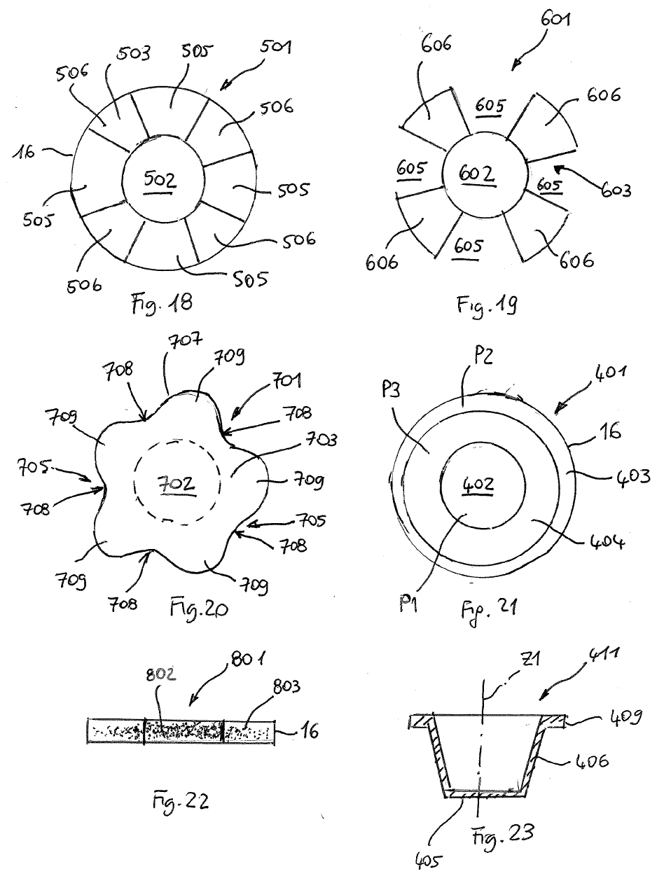

FIG. 20 shows a dose 701 to obtain a concave object according to an alternative version. The dose 701 comprises a central portion 702, similar to the central portion 502 described above, intended to form the end wall of the object. The central portion 702 is surrounded by a peripheral portion 703, intended to form the lateral wall of the finished object.

The central portion 702 has been indicated in FIG. 20 as delimited by a dashed line. This dashed line is a theoretical line, which may not correspond to any variation in the dose 701. In fact, the thickness and the density of the central portion 702 may be equal to those of the peripheral portion 703. Alternatively, the thickness and/or the density of the dose 701 in the central portion 702 may be different from those of the peripheral portion 703.

The peripheral portion 703 extends continuously around the central portion 702. The peripheral portion 703 is delimited by a perimeter region 707 having an undulating shape. Along the perimeter region 707, curved indentations 708 are defined, which penetrate towards the inside of the dose 701, that is to say, towards the central portion 702, and curved protrusions 709, which protrude towards the outside of the dose 701.

The curved indentations 708 delimit compensating zones 705, in which the material is absent, intended to compensate for the excesses of material resulting from the formation of folds in which the natural fibre-based material tends to superpose. The curved protrusions define, on the other hand, functional zones 706 which are used to obtain a lateral wall of the finished object having the desired properties.

FIG. 22 shows a dose 801 according to an alternative version, which comprises a central portion 802 having a substantially constant thickness and density. The dose 801 also comprises a peripheral portion 803 in which the density of the natural fibre-based material decreases progressively from the value which it had in the central portion 802 to a predetermined minimum value close to the outer edge 16. The minimum value is selected depending on the desired properties for the finished object, for example the height. A dose of this type allows a thickness which is better distributed in the finished object to be achieved.

The doses described above may be used for pressure forming a plurality of objects different to each other, for example concave objects such as containers of various types, capsules for coffee or for other food or non-food products, concave non-axially symmetric objects, flat objects, such as tiles or slabs, or objects having a relatively complex shape, such as bottles, necks of containers, dispensing devices for containers, spouts and other items.

Moreover, all the doses described above are discrete doses each of which is dimensioned to form a single object.

Below are some clauses concerning embodiments of the invention.
Clause 1: A method comprising the steps of:
   supplying a dose (1; 101; 201; 301) made with a natural fibre-based material;
   inserting the dose (1; 101; 201; 301) in a mould (20) between a first half-mould (21) and a second half-mould (22);
   moving at least one half-mould, selected from the first half-mould (21) and the second half-mould (22), towards the other half-mould, selected from the second half-mould (22) and the first half-mould, (21) along a pressing direction (D) to press the dose (1; 101; 201; 301) between the first half-mould (21) and the second half-mould (22) thereby forming an object (4; 104),
      wherein the dose (1; 101; 201; 301) has a non-uniform structure.
Clause 2: The method according to clause 1, wherein the dose (1) has at least a first portion (2) having a first thickness (S1) and at least a second portion (3) having a second thickness (S2), the first thickness (S1) being greater than the second thickness (S2).
Clause 3: The method according to clause 1, wherein the dose (101) has a first portion (102) and a second portion (103), the first portion (102) having a density greater than the density of the second portion (103).
Clause 4: The method according to clause 2 or 3, wherein the first portion (2; 102) is used to form a first part (5) of the object (4; 104) and the second portion (3; 103) is used to form a second part (6) of the object (4), the first part (5) of the object (4; 104) on average being thicker than the second part (6) of the object (4; 104).
Clause 5: The method according to clause 1, wherein at least one preferential deformation line (17; 317) is provided on a surface (13) of the dose (201; 301), the preferential deformation line (17; 317) defining on the dose (201; 301) a first portion (202; 302) and a second portion (203; 303), and being configured to assist the second portion (203; 303) in bending relative to the first portion (202; 302) when the dose (201; 301) is pressed between the first half-mould (21) and the second half-mould (22).
Clause 6: The method according to clause 5, wherein the preferential deformation line (17; 317) is a local compression zone (14).
Clause 7: The method according to clause 5, wherein the preferential deformation line (17; 317) is a cut (18) which partly passes through the thickness of the dose (301).
Clause 8: The method according to any one of clauses 5 to 7, wherein the preferential deformation line (17; 317) is a closed line which surrounds the first portion (202; 302) of the dose (201; 301), and wherein the second portion (203; 303) of the dose (201; 301) is arranged outside the preferential deformation line (17; 317).
Clause 9: The method according to any one of clauses 5 to 8, wherein the dose (203) furthermore comprises a plurality of further preferential deformation lines (15) which spread out from the preferential deformation line (17) towards an outer edge (16) of the dose (203).
Clause 10: The method according to clause 9, wherein the further preferential deformation lines (15) are local compression zones.
Clause 11: The method according to any one of clauses 2 to 10, wherein the first portion (2; 102; 202; 302) is a central portion of the dose (1; 101; 201; 301) and the second portion (3; 103; 203; 303) is a peripheral portion of the dose (1; 101; 201; 301), or alternatively wherein the second portion (3; 103; 203; 303) is a central portion of the dose (1; 101; 201; 301) and the first portion (2; 102; 202; 302) is a peripheral portion of the dose (1; 101; 201; 301), and wherein the peripheral portion surrounds the central portion.
Clause 12: The method according to clause 11, wherein the object (4; 104) has a concave shape and comprises an end wall (5) and a lateral wall (6) which projects from the end wall (5), and wherein the central portion of the dose (1; 101; 201; 301) is used to create at least the end wall (5) and the peripheral portion of the dose (1; 101; 201; 301) is used to create at least a part of the lateral wall (6), for example a tamper-evident band (9) included in the lateral wall (6).
Clause 13: The method according to clause 12, wherein the object (4; 104) is a cap for a container, or a container, or a capsule.
Clause 14: The method according to any one of clauses 2 to 13, wherein a portion of the dose (1; 101; 201; 301) selected between the first portion (2; 102; 202; 302) and the second portion (3; 103; 203; 303) has a substantially circular shape in plan view, and wherein another portion of the dose (1; 101; 201; 301) selected between the second portion (3; 103; 203; 303) and the first portion (2; 102; 202; 302) has an annulus shape in plan view which surrounds the portion of the dose (1; 101; 201; 301) having a substantially circular shape in plan view.
Clause 15: The method according to any one of clauses 2 to 14, wherein the first portion (2; 102; 202; 302) and the second portion (3; 103; 203; 403) are used to form respective parts of the object (4; 104) having different densities.
Clause 16: The method according to any one of clauses 1 to 15, wherein the dose (1; 101; 201; 301) has a multi-layer structure and comprises at least a covering layer and at least a supporting layer.
Clause 17: A dose made with a natural fibre-based material, the dose (1; 101; 201; 301) being suitable for undergoing forming by means of pressing to obtain an object (4; 104), wherein the dose has a non-uniform structure.
Clause 18: The dose according to clause 17, comprising a first portion (2) having a first thickness (S1) and a second portion (3) having a second thickness (S2), the first thickness (S1) being greater than the second thickness (S2).
Clause 19: The dose according to clause 17, comprising a first portion (102) and a second portion (103), the first portion (102) having a density greater than the density of the second portion (103).
Clause 20: The dose according to clause 17, and furthermore comprising a local compression zone (14) made on a surface (13) of the dose (201) and surrounding a central portion (202) of the dose (201).
Clause 21: The dose according to clause 20, and furthermore comprising a plurality of further local compression zones (15) made on said surface (13), the further local compression zones (15) extending from the local compression zone (14) towards a free edge (16) of the dose (201).
Clause 22: The dose according to clause 17, furthermore comprising a cut line (18) made on a surface (13) of the dose (301) and surrounding a central portion (302) of the dose (301), the cut line (18) partly passing through the thickness of the dose (301).

1. A method comprising the steps of:
supplying a dose made with a natural fibre-based material;
inserting the dose in a mould between a first half-mould and a second half-mould;
moving at least one half-mould, selected from the first half-mould and the second half-mould, towards the other half-mould, selected from the second half-mould and the first half-mould along a pressing direction to press the dose between the first half-mould and the second half-mould thereby forming an object,
wherein the dose has a non-uniform structure, thickness being greater in a first portion of the dose than in a second portion of the dose, and wherein the first portion of the dose forms a first part of the object which is on average thicker than a second part of the object formed by the second portion of the dose.

2. A method comprising the steps of:
supplying a dose made with a natural fibre-based material;
inserting the dose in a mould between a first half-mould and a second half-mould;
moving at least one half-mould, selected from the first half-mould (21) and the second half-mould, towards the other half-mould, selected from the second half-mould and the first half-mould along a pressing direction to press the dose between the first half-mould and the second half-mould thereby forming an object,
wherein the dose has a non-uniform structure, a property of the dose selected from density and thickness being greater in a first portion the dose than in a second portion of the dose, and wherein the first portion of the dose forms a first part of the object which has on average a higher density than a second part of the object formed by the second portion of the dose.

3. The method according to claim 2, wherein the first portion is a central portion of the dose and the second portion is a peripheral portion of the dose, or alternatively wherein the second portion is a central portion of the dose and the first portion is a peripheral portion of the dose, and wherein the peripheral portion surrounds the central portion.

4. The method according to claim 3, wherein the peripheral portion is delimited by an outer edge of the dose.

5. The method according to claim 2, wherein the first portion of the dose has a grammage of between 600 and 1200 g/m² and the second portion of the dose has a grammage of between 250 and 750 g/m², the grammage of the first portion being greater than the grammage of the second portion.

6. The method according to claim 2, wherein the property of the dose which is greater in the first portion than in the second portion is density, and wherein the dose has a substantially constant thickness.

7. The method according to claim 2, wherein the first portion of the dose has a thickness and the second portion of the dose has a further thickness, the thickness being greater than the further thickness, the difference between the thickness and the further thickness being between 0.5 mm and 10 mm.

8. The method according to claim 2, wherein the dose has an intermediate portion interposed between the first portion and the second portion, and wherein said property of the dose selected from density and thickness has, in the intermediate portion, a value less than in the first portion and greater than in the second portion.

9. The method according to claim 2, wherein the object has a concave shape and comprises an end wall and a lateral wall which projects from the end wall, and wherein the first portion of the dose is used to create at least the end wall and the second portion of the dose is used to create at least a part of the lateral wall.

10. The method according to claim 2, wherein the object is a capsule and comprises an end wall, a lateral wall which projects from the end wall and a flange arranged at an end of the lateral wall opposite the end wall, and wherein the first portion of the dose is used to create at least the flange and the second portion of the dose is used to create at least the end wall.

11. The method according to claim 2, wherein a portion of the dose selected from the first portion and the second portion has a substantially circular shape in plan view, and wherein another portion of the dose selected from the second portion and the first portion has an annulus shape in plan view, said another portion being arranged outside the portion of the dose having a substantially circular shape in plan view.

12. The method according to claim 2, wherein the dose has a multilayer structure and comprises at least a covering layer and at least a supporting layer.

13-19. (canceled)

20. A method for obtaining a concave object, comprising the steps of:
supplying a dose made with a natural fibre-based material, the dose comprising a central portion for forming an end wall of the concave object and a peripheral portion for forming a lateral wall of the concave object, the peripheral portion comprising a plurality of functional zones, the dose further comprising a plurality of compensating zones, each compensating zone of the plurality of compensating zones being interposed between two functional zones of the plurality of functional zones;
inserting the dose in a mould between a first half-mould and a second half-mould;
moving at least one half-mould, selected from the first half-mould and the second half-mould, towards the other half-mould, selected from the second half-mould and the first half-mould along a pressing direction for pressing the dose between the first half-mould and the second half-mould thereby forming said concave object,
wherein the compensating zones of the plurality of compensating zones compensate for an increases in thickness due to folds originated while the peripheral portion is shaped to form the lateral wall, by receiving excesses of material of the folds.

21. The method according to claim 20, wherein the compensating zones of the plurality of compensating zones have a surface equal to at least 20% of a surface of the dose, in a plan view.

22. The method according to claim 20, wherein each compensating zone of the plurality of compensating zones is an empty space interposed between two adjacent functional zones of the plurality of functional zones.

23. The method according to claim 22, wherein when the dose is pressed to obtain the concave object, the functional zones of the plurality of functional zones rotate relative to the central portion and widen in a circumferential direction, so that two adjacent functional zones of the plurality of functional zones touch along their sides and join to form the lateral wall, whereby the lateral wall is an uninterrupted lateral wall.

24. The method according to claim 20, wherein a property of the dose selected from density and thickness has a smaller value in the compensating zones of the plurality of compensating zones than in the functional zones of the plurality of functional zones.

25. The method according to claim 20, wherein the dose is delimited by a perimeter region having an undulating shape.

26. The method according to claim 9, wherein the second portion of the dose is used to create a tamper-evident band included in the lateral wall.
